(19) United States
(12) Patent Application Publication
(10) Pub. No.: US 2023/0185148 A1
(43) Pub. Date: Jun. 15, 2023

(54) LONG-RANGE ELECTROCHROMIC FIBER FOR INFRARED CAMOUFLAGE AND PREPARATION METHOD THEREOF

(71) Applicant: DONGHUA UNIVERSITY, Shanghai (CN)

(72) Inventors: Hongzhi WANG, Shanghai (CN); Hongwei FAN, Shanghai (CN); Yaogang LI, Shanghai (CN); Qinghong ZHANG, Shanghai (CN); Chengyi HOU, Shanghai (CN)

(73) Assignee: DONGHUA UNIVERSITY, Shanghai (CN)

(21) Appl. No.: 17/926,137

(22) PCT Filed: Apr. 30, 2021
(86) PCT No.: PCT/CN2021/091238

§ 371 Date: Nov. 18, 2022

(30) Foreign Application Priority Data
Jul. 8, 2020 (CN) 202010651173.5

(51) Int. Cl. G02F 1/155; G02F 1/153; G02F 1/1343; C09D 5/24; C09D 7/20; C09D 7/61; C09D 7/63; C09D 127/16; C09D 179/02; C09D 165/00; C09D 123/06; D06M 11/46; D06M 11/30; D06M 15/256; D06M 15/63; D06M 11/81; D06M 15/227; D06M 15/513

(52) U.S. Cl. CPC G02F 1/155; G02F 1/1533; G02F 1/13439; C09D 5/24; C09D 7/20; C09D 7/61; C09D 7/63; C09D 127/16; C09D 179/02; C09D 165/00; C09D 123/06; D06M 11/46; D06M 11/30; D06M 15/256; D06M 15/63; D06M 11/81; D06M 15/227; D06M 15/513; G02F 2001/1552; G02F 2001/1536; G02F 2001/1555; G02F 2203/11; G02F 2201/02; G02F 2001/164

(57) ABSTRACT

A long-range electrochromic fiber for infrared camouflage and preparation method thereof are disclosed. The method includes: coating indium tin oxide dispersion, electrolyte solution, and electrochromic material on the surface of the metal fiber sequentially, and preparing counter electrodes and polymer protective layer on the outside of the electrochromic layer to obtain the long-range electrochromic fiber. The obtained long-range electrochromic fiber can realize the regulation of infrared emissivity, can be continuously prepared for more than 100 meters and has a good application prospect in infrared camouflage, wearable display, etc.

### CROSS REFERENCE TO THE RELATED APPLICATIONS

This application is the national phase entry of International Application No. PCT/CN2021/091238, filed on Apr. 30, 2021, which is based upon and claims priority to Chinese Patent Application No. 202010651173.5, filed on Jul. 8, 2020, the entire contents of which are incorporated herein by reference.

### TECHNICAL FIELD

The invention belongs to the field of electrochromic devices, in particular to a long-range electrochromic fiber for infrared camouflage and preparation method thereof.

### BACKGROUND

Fiber, as the basic building unit of clothing and fabric, has been closely related to modern society. In recent years, smart fabrics with controllable color changes have attracted extensive attention because of their application prospects in wearable display, visual sensing, and adaptive camouflage. However, due to the passive optical properties of traditional dyes, the color of existing commercial fibers cannot be changed as required. Therefore, the fibers with controllable color changes are urgently needed to realize various smart applications.

At present, a variety of smart color-changing fibers that can change color according to different stimulus sources have been reported, including electrochromic fibers, photochromic fibers, magnetochromic fibers, thermochromic fibers, etc. However, electricity is undoubtedly the most convenient and controllable driving means. The electrochromic materials have the advantages of rich color changes, fast response time, good stability, etc. In the wearable field, the electrochromic fiber can effectively solve the disadvantages of non-fit between two-dimensional devices and clothing, poor air permeability, and inability to integrate into a large area.

Despite some electrochromic fibers research having been reported, there still existed many shortcomings and difficulties in pushing the electrochromic fibers to practical applications. First and most importantly, due to the complex device structure and immature continuously-processed technology, the electrochromic fibers were hand-made in the laboratory, which led to the limited fiber length, and thus were not able to satisfy the industrial requirement. Second, for long-range electrochromic fibers, it is difficult to realize fast electron transfer/ionic diffusion to guarantee the uniformity of color changes, due to the much longer transfer/diffusion pathway. Third, there is a lack of effective protection for the electrolytes and other active layers of electrochromic fibers. Therefore, directly exposed electrochromic fibers in the air will lead to poor environmental stability, which is disadvantageous to long-term practical usage. At last, the preparation method should be generalized for constructing various electrochromic fibers based on different electrochromic active materials for abundant color changes.

Electrochromic devices have been widely studied in automotive rearview mirrors, smart windows, and electrochromic displays, and some of them have been commercially produced. However, these mainly focus on the regulation in the visible and near-infrared bands. Some electrochromic materials also have the regulation ability in the mid-infrared spectrum, which can be used in infrared camouflage, thermal management, and other fields. Infrared electrochromic materials mainly include tungsten oxide, conductive polymers (poly (3,4-ethylene dioxythiophene), polyaniline, polypyrrole), etc. Compared with transition metal oxides, conductive polymers have the advantages of lightweight, good flexibility, large infrared modulation range, fast switching time, and simple preparation process, which are more suitable for practical application. The infrared regulation of clothing can be simply and effectively realized by preparing electrochromic fibers with infrared regulation and integrating electrochromic fibers with clothing or fabrics by weaving or implantation. It has an important application prospect in adaptive infrared camouflage. Therefore, it is urgent to prepare long-range electrochromic fibers by using infrared electrochromic materials.

Chinese patent CN101833211A discloses a smart dimming glass. The electrochromic glass adopts zinc sulfide-silver-zinc sulfide, tin indium oxide, fluorine-doped tin oxide, or aluminum-doped zinc oxide as the conductive layer to realize the function of infrared reflection. However, this smart dimming glass cannot dynamically control the infrared emissivity, mainly to adjust the color change in the visible light range, and the glass device is not suitable for clothing. The long-range electrochromic fiber for infrared camouflage prepared by the invention not only overcomes the difficulty of long-range preparation of electrochromic fiber due to complex structure but also realizes the controllable regulation of infrared band through fiber structure design and material selection.

### SUMMARY

The technical problem to be solved by this invention which provides a long-range electrochromic fiber for infrared camouflage and preparation method thereof. In the invention, the controllable regulation of infrared emissivity is realized through the color change of electrochromic material. In addition, the long-range preparation of electrochromic fibers is realized through customized and assembled continuous production equipment.

An electrochromic fiber with infrared regulation, wherein the structure of fiber from inside to outside is metal fiber inner electrode, ITO layer, electrolyte layer, electrochromic layer, counter electrodes, and polymer protective layer.

Wherein the components of the electrolyte layer include: lithium perchlorate (LiClO₄), organic solvent, ionic liquid, polyvinylidene fluoride hexafluoropropylene (PVDF-HFP); wherein the volume ratio of organic solvent to ionic liquid is 9:1-2:3; wherein the mass ratio of organic solvent to PVDF-HFP is 1:0.5-1:1.5.

Wherein the electrochromic material is at least one of poly (3,4-ethylene dioxythiophene) (PEDOT), polyaniline (PANT), and multilayer graphene.

Wherein the counter electrode is the metal fiber coated with ITO coating; wherein the counter electrode is the spiral counter electrode structure and/or the parallel counter electrode structure; wherein the spiral counter electrode can be divided into the single spiral electrode and multiple spiral electrodes, and the parallel counter electrode can be divided into the single parallel electrode and multiple parallel electrodes; wherein the thickness of ITO coating on the counter electrode is 4-15 μm.

Wherein the thickness of the electrolyte is 60-180 μm, and the thickness of the polymer protective layer is 0.1-0.3 mm.

Wherein the thickness of the ITO layer is 4-15 μm.

The coloring voltage range applied to the electrochromic fiber is −2.0 V to −0.9 V, and the bleaching voltage range applied is 0.9-2.0 V.

The preparation method of an electrochromic fiber, includes:

(1) Indium tin oxide (ITO) dispersion, electrolyte solution, and electrochromic materials are successively coated on the surface of the metal fiber, and heated and dried successively.

(2) An electrochromic fiber is obtained by coating a polymer protective layer on the outside of the electrochromic layer and placing the counter electrode between the electrochromic layer and the polymer protective layer.

The preferred method of the above preparation method is as follows:

Wherein the electrolyte solution in step (1) is specifically: the LiClO₄ is dissolved in the mixture of organic solvent and ionic liquids. Then, PVDF-HFP is added to the mixture and stirred evenly to obtain the electrolyte; The volume ratio of organic solvent to ionic liquid is 9:1-2:3; The mass ratio of organic solvent to PVDF-HFP is 1:0.5-1:1.5.

Wherein the organic solvent is one or more of propylene carbonate (PC), N-methylpyrrolidone (NMP) and N, N-dimethylformamide (DMF); Ionic liquid is 1-butyl-3-methy limidazo le tetrafluorob orate [BMIm][BF₄], 1-ethyl-3-methylimidazole bis trifluoromethylsulfonimide [EMIm][TFSI] or 1-butyl-1-methylpyrrolidine bis trifluoromethylsulfonimide [BMPyr][TFSI].

In step (1), the metal fiber is pulled by the power transmission device, each layer is coated on the surface of the metal fiber through the solution tank successively, then heated and cured by the heating device; The fiber transmission speed is 1-5 m/min; The pore diameter of the solution tank is 0.4-1 mm; The heating temperature is 90-140° C.

In step (2), the counter electrode is spirally wound or attached in parallel to the fiber surface prepared in step (1), and then the polymer protective layer is coated on the outermost layer by extrusion.

The invention relates to a device for preparing electrochromic fiber, which comprises the power transmission device, solution coating mold (solution tank), heating device, first collection device, counter electrode introduction device, extruder, cooling device, and second collection device;

Driven by the power transmission device, the metal fibers pass through the solution tank and heating device in turn and are collected through the first collection device, then the counter electrode is placed through the electrode introduction device, and the polymer protective layer is coated through the extruder.

The function of the electrode introduction device is to wind the counter electrode on the fiber surface in the form of parallel or spiral.

The invention provides an application of the said electrochromic fiber in fields such as infrared camouflage, wearable display, etc.

The invention realizes the controllable regulation of infrared emissivity through the color change of electrochromic material. The metal fiber is used as the conductive electrode. The surface of the metal fiber is successively coated with indium tin oxide dispersion, electrolyte solution, and electrochromic material by customized and assembled continuous construction equipment. Then, the counter electrode and polymer protective layer are prepared outside the electrochromic layer to obtain the long-range electrochromic fiber.

### Benefits:

(1) The continuous production line of electrochromic fiber is assembled by customized equipment, and realizes the long-range controllable preparation of electrochromic fiber, which can continuously prepare more than 100 meters;

(2) The preparation method of the invention can be applied to the preparation of fibers with various materials and has universal applicability;

(3) The electrochromic fiber prepared by the invention can change the absorption rate of the electrochromic material to infrared light through ion injection/extraction in the electrochromic process, to realize the controllable regulation of infrared emissivity. The electrochromic fiber can be woven into fabric or implanted into clothing and fabrics and has good application prospects in infrared camouflage.

### BRIEF DESCRIPTION OF THE DRAWINGS

FIGS. 1A and 1B are continuous preparation process schemes of long-range electrochromic fiber: FIG. 1A is a multilayer structure preparation scheme of electrochromic fiber; FIG. 1B is a preparation scheme of the counter electrode and protective layer; wherein, 1 is the solution tank, 2 is the heating device, 3 is the collection device, 4 is the counter electrode introduction device, 5 is the extruder and 6 is the cooling device.

FIG. 2 is a scheme of electrochromic fibers with different structures, wherein, 1 is the metal fiber inner electrode, 2 is the ITO layer, 3 is the electrolyte layer, 4 is the electrochromic layer, 5 is the metal fiber counter electrode coated with ITO, and 6 is the polymer protective layer.

FIG. 3 is a digital photograph of long-range electrochromic fiber.

FIG. 4 is infrared reflection spectra of electrochromic fiber before and after the color change.

### DETAILED DESCRIPTION OF THE EMBODIMENTS

The invention is further described in combination with specific examples. It should be understood that these examples are only used to illustrate the invention and not to limit the scope of the invention. In addition, it should be understood that after reading the content of the invention, the technicians of this field can make various changes or modifications to the invention, and these equivalent forms also fall within the scope defined by the claims attached to the application.

The preparation device comprises the power transmission device, solution tank, heating device, first collection device, counter electrode introduction device, extruder, cooling device, and second collection device.

Driven by the power transmission device, the metal fiber pass through the solution tank and the heating device in turn and is collected through the collection device. The solution tank is filled with ITO dispersion, electrolyte solution, and electrochromic solution respectively, then coated on the surface of metal fiber in turn, and heated and dried successively. The metal fiber counter electrode coated with the ITO layer is wound in parallel or spiral on the surface of the above-prepared fiber, and the polymer protective layer is prepared on the outer layer through the extruder. Finally, electrochromic fiber is collected by the collection device.

Metal fiber (diameter: 0.1 mm and 0.3 mm. The counter electrode is 0.1 mm. The inner electrode is 0.3 mm), indium tin oxide dispersion and polyethylene (molecular weight: about 200000) are provided by Shanghai Keyan Photoelectric Technology Co., Ltd. Lithium perchlorate (99%) and organic solvents such as propylene carbonate were purchased from Sinopharm Chemical Reagent Co., Ltd. Ionic liquids were purchased from Shanghai Moni Chemical Technology Co., Ltd. Poly (3,4-ethylene dioxythiophene) (brand: F010) was purchased from Shanghai Jingnian Chemical Co., Ltd. Polyaniline (98%) was purchased from Cool Chemical Technology (Beijing) Co., Ltd. and multilayer graphene (1 wt.%) was purchased from Suzhou Yougao Nanomaterials Co., Ltd. Polyvinylidene fluoride hexafluoropropylene (PVDF-HFP, brand: 21216) was purchased from Shenzhen Taotao Plastic Co., Ltd.

The thickness of the ITO layer is 6-10 μm; the ITO coating on the surface of the metal fiber is 6-10 μm.

### Example 1

The ITO was used as the electrochemical protective layer of the metal electrode, and PEDOT was used as the electrochromic layer.

The LiClO₄ (1 M) was dissolved in the mixture of PC and [BMIm][BF₄] (volume ratio is 1:1). Then, PVDF-HFP was added to the mixture and stirred evenly to obtain the electrolyte (mass ratio of PVDF-HFP to PC is 1:1).

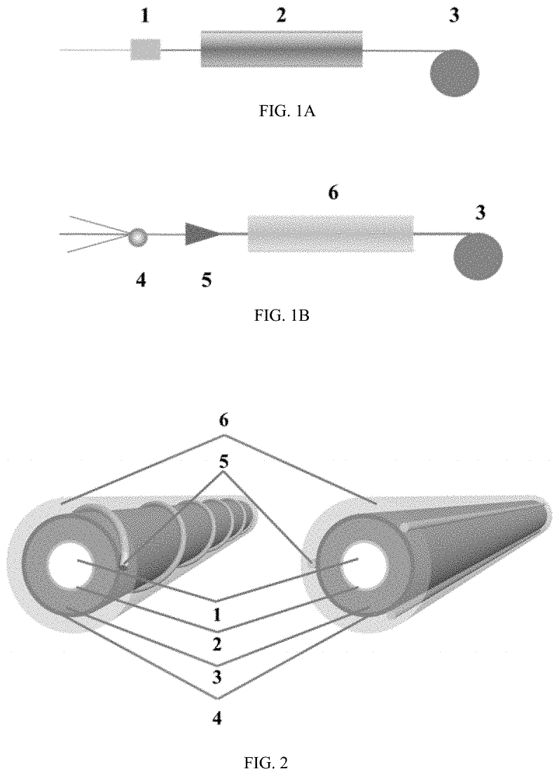

ITO dispersion, electrolyte solution, and PEDOT dispersion were successively coated on the surface of metal fiber through the solution tank by using the customized continuous preparation device (FIGS. 1A and 1B), the fiber was collected after high-temperature curing. The thickness of the electrolyte layer was about 120 μm. The pore diameter of the solution tank was 0.69 mm. The fiber transmission speed was 3 m/min. The curing temperature was 110° C.

The metal fiber coated with ITO was spirally wound on the surface of the above fiber, and the polyethylene protective layer was prepared on the outer layer by extrusion. The thickness of the protective layer was 0.2 mm. Finally, the electrochromic fiber was collected. Under the voltage of −1.5 V, the coloring time of 10 cm long electrochromic fiber is 0.8 s. Under the voltage of 1.5 V, the bleaching time of electrochromic fiber is 0.7 s. In the wavelength range of 2.5-20 μm, the change of infrared reflectance of electrochromic fiber before and after the color change is about 20%.

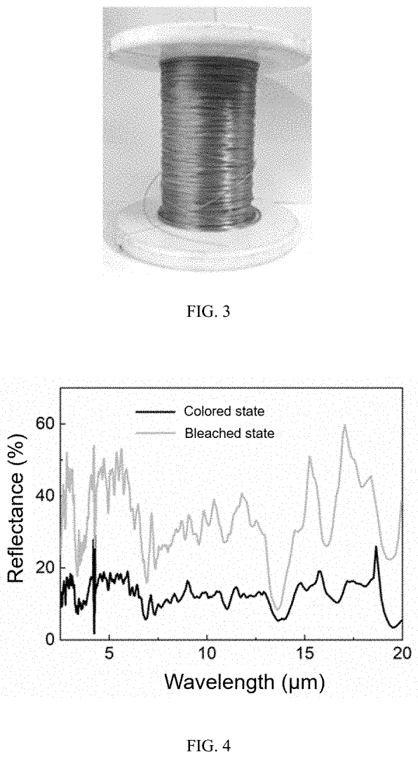

FIGS. 1A and 1B are the continuous preparation process schemes of long-range electrochromic fiber: FIG. 1A is a multilayer structure preparation scheme of electrochromic fiber; FIG. 1B is a preparation scheme of the counter electrode and protective layer. FIG. 2 is the scheme of electrochromic fibers with different structures. FIG. 3 is the digital photograph of long-range electrochromic fiber. FIG. 4 is the infrared reflection spectra of electrochromic fiber before and after the color change.

### Example 2

The ITO was used as the electrochemical protective layer of the metal electrode, and PEDOT was used as the electrochromic layer.

The LiClO₄ (1 M) was dissolved in the mixture of PC and [BMIm][BF₄] (volume ratio is 1:1). Then, PVDF-HFP was added to the mixture and stirred evenly to obtain the electrolyte (mass ratio of PVDF-HFP to PC is 1:1).

ITO dispersion, electrolyte solution, and PEDOT dispersion were successively coated on the surface of metal fiber through the solution tank by using the customized continuous preparation device (FIGS. 1A and 1B), the fiber was collected after high-temperature curing. The thickness of the electrolyte layer was about 120 μm. The pore diameter of the solution tank was 0.69 mm. The fiber transmission speed was 3 m/min. The curing temperature was 110° C.

The metal fiber coated with ITO was spirally wound on the surface of the above fiber, and the polyethylene protective layer was prepared on the outer layer by extrusion. The thickness of the protective layer was 0.2 mm. Finally, the electrochromic fiber was collected. The electrochromic fiber was colored under the voltage of −0.9 V and bleached under the voltage of 0.9 V.

Since the voltage applied to the electrochromic fiber was reduced, which reduced the doping degree of ions in the electrolyte to the electrochromic material, resulting in the change of infrared reflectance before and after fiber color change being lower than that in example 1. The change of infrared reflectance of electrochromic fiber before and after the color change was about 10%.

### Example 3

The ITO was used as the electrochemical protective layer of the metal electrode, and PEDOT was used as the electrochromic layer.

The LiClO₄ (1 M) was dissolved in the mixture of PC and [BMIm][BF₄] (volume ratio is 1:1). Then, PVDF-HFP was added to the mixture and stirred evenly to obtain the electrolyte (mass ratio of PVDF-HFP to PC is 0.5:1).

ITO dispersion, electrolyte solution, and PEDOT dispersion were successively coated on the surface of metal fiber through the solution tank by using the customized continuous preparation device (FIGS. 1A and 1B), the fiber was collected after high-temperature curing. The thickness of the electrolyte layer was about 60 μm. The pore diameter of the solution tank was 0.69 mm. The fiber transmission speed was 5 m/min. The curing temperature was 90° C.

The metal fiber coated with ITO was spirally wound on the surface of the above fiber, and the polyethylene protective layer was prepared on the outer layer by extrusion. The thickness of the protective layer was 0.2 mm. Finally, the electrochromic fiber was collected.

The solubility of PVDF-HFP in the electrolyte was reduced due to the decrease of PVDF-HFP content, the increase in transmission speed, and the decrease in curing temperature, and the electrolyte strength is lower than that in example 1.

### Example 4

The ITO was used as the electrochemical protective layer of the metal electrode, and PEDOT was used as the electrochromic layer. The LiClO₄ (1 M) was dissolved in the mixture of PC and [BMIm][BF₄] (volume ratio is 4:1). Then, PVDF-HFP was added to the mixture and stirred evenly to obtain the electrolyte (mass ratio of PVDF-HFP to PC is 1.5:1).

ITO dispersion, electrolyte solution, and PEDOT dispersion were successively coated on the surface of metal fiber through the solution tank by using the customized continuous preparation device (FIGS. 1A and 1B), the fiber was collected after high-temperature curing. The thickness of the electrolyte layer was about 120 μm. The pore diameter of the solution tank was 0.69 mm. The fiber transmission speed was 1 m/min. The curing temperature was 140° C.

The metal fiber coated with ITO was spirally wound on the surface of the above fiber, and the polyethylene protective layer was prepared on the outer layer by extrusion. The thickness of the protective layer was 0.2 mm. Finally, the electrochromic fiber was collected.

Due to the increase of PVDF-HFP content and the decrease of ionic liquid content in the electrolyte, hindered the diffusion of ions in the electrolyte, resulting in the decrease in ionic conductivity. In addition, the increase in the curing temperature of the electrolyte promoted solvent volatilization, which also reduced the ionic conductivity of the electrolyte. Therefore, the switching time of the fiber was longer than that in example 1. The coloring time of electrochromic fiber was 2.1 s and the bleaching time was 1.9 s.

What is claimed is:

1. An electrochromic fiber, wherein structures from inside to outside are: a metal fiber inner electrode, an ITO layer, an electrolyte layer, an electrochromic layer, a counter electrode, and a polyethylene protective layer.

2. The electrochromic fiber of claim 1, wherein components of the electrolyte layer comprise: lithium perchlorate (LiClO₄), an organic solvent, an ionic liquid, and polyvinylidene fluoride hexafluoropropylene (PVDF-HFP); wherein an electrochromic material is at least one of poly (3,4-ethylene dioxythiophene) (PEDOT), polyaniline (PANI), and a multilayer graphene.

3. The electrochromic fiber of claim 1, wherein the counter electrode is a metal fiber coated with an ITO coating; wherein the counter electrode is a spiral counter electrode structure and/or a parallel counter electrode structure.

4. The electrochromic fiber of claim 1, wherein a thickness of the electrolyte layer is 60 μm-180 μm, and a thickness of the polyethylene protective layer is 0.1 mm-0.3 mm.

5. A method for preparing an electrochromic fiber, comprising:
(1) coating an indium tin oxide (ITO) dispersion, an electrolyte solution, and electrochromic materials on a surface of a metal fiber in turn, and heating and drying successively;
(2) coating a polymer protective layer on an outside of an electrochromic layer and placing a counter electrode between the electrochromic layer and the polymer protective layer, to obtain the electrochromic fiber.

6. The method of claim 5, wherein the electrolyte solution in step (1) is: LiClO₄ is dissolved in a mixture of an organic solvent and an ionic liquid, then PVDF-HFP is added to the mixture and stirred evenly to obtain the electrolyte solution; wherein a volume ratio of the organic solvent to the ionic liquid is 9:1-2:3; and a mass ratio of the organic solvent to the PVDF-HFP is 1:0.5-1:1.5.

7. The method of claim 5, wherein the metal fiber in step (1) is pulled by a power transmission device, each layer is coated on the surface of the metal fiber through a solution tank successively, then heated and cured by a heating device; wherein a fiber transmission speed is 1 m/min-5 m/min; wherein a pore diameter of the solution tank is 0.4 mm-1 mm; wherein a heating temperature is 90° C.-140° C.

8. The method of claim 5, wherein in step (2), the counter electrode is spirally wound or attached in parallel to a fiber surface prepared in step (1), and then the polymer protective layer is coated on an outermost layer by an extrusion.

9. A device for preparing an electrochromic fiber, comprising a power transmission device, a solution coating mold, a heating device, a first collection device, a counter electrode introduction device, an extruder, a cooling device, and a second collection device;
wherein driven by the power transmission device, metal fibers pass through a solution tank and the heating device in turn and are collected through the first collection device.

10. A method of an application of the electrochromic fiber of claim 1.
